(19) United States
(12) Patent Application Publication
(10) Pub. No.: US 2026/0371158 A1
(43) Pub. Date: Nov. 19, 2026

(54) Methods of Application Layer Measurement Reporting

(71) Applicant: Apple Inc., Cupertino, CA (US)

(72) Inventors: Ping-Heng KUO, London (GB); Ralf ROSSBACH, Munich (DE); Peng CHENG, Beijing (CN); Naveen Kumar R PALLE VENKATA, San Diego, CA (US)

(21) Appl. No.: 19/155,329

(22) PCT Filed: Feb. 2, 2024
(86) PCT No.: PCT/US2024/014317

§ 371 Date: Aug. 11, 2025

Related U.S. Application Data
(60) Provisional application No. 63/485,127, filed on Feb. 15, 2023.

(51) Int. Cl. H04W 28/02; H04W 24/08; H04W 24/10

(52) U.S. Cl. CPC H04W 28/0278; H04W 24/08; H04W 24/10

(57) ABSTRACT

Methods are disclosed herein related to providing improved user equipment (UE) behaviors in instances of the discarding of data units (e.g., packets, Protocol Data Units (PDU), PDU sets, etc.). In particular, methods are disclosed, comprising: detecting an event at a UE, wherein the event comprises one or more buffered protocol data units being discarded by the UE; and triggering, in response to the detected event, the UE to report an application layer measurement result to a base station.

### TECHNICAL FIELD

The present application relates to wireless devices and wireless networks, including user devices, terminals, circuits, computer-readable media, and methods for the handling of application layer measurements results (e.g., quality of experience (QoE) measurement results) in situations of buffered data unit discarding (e.g., the discarding of data packets or protocol data unit (PDU) sets).

### BACKGROUND

Wireless communication systems are rapidly growing in usage. In recent years, wireless devices such as smart phones and tablet computers have become increasingly sophisticated. In addition to supporting telephone calls, many mobile devices now provide access to the Internet, email, text messaging, and navigation using the global positioning system (GPS) and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), Long-Term Evolution (LTE), LTE Advanced (LTE-A), HSPA, 3GPP2 CDMA2000 (e.g., 1xRTT, 1xEV-DO, HRPD, eHRPD), IEEE 802.11 (WLAN or Wi-Fi), and BLUETOOTH™, among others.

The ever-increasing number of features and functionality introduced in wireless communication devices also creates a continuous need for improvement in both wireless communications and in wireless communication devices. To increase coverage and better serve the increasing demand and range of envisioned uses of wireless communication, in addition to the communication standards mentioned above, there are further wireless communication technologies under development, including the fifth generation (5G) standard and New Radio (NR) communication technologies. Accordingly, improvements in the field in support of such development and design are desired.

Media flows can now be carried over wireless networks, but the transmission of media content can be especially challenging for applications with high-throughput and low latency requirements, such as video conferencing and so-called Extended Reality (XR) applications, wherein XR is defined as an umbrella term referring to all aspects of Virtual Reality (VR), Augmented Reality (AR), and/or Mixed Reality (MR). Wireless networks can implement techniques to improve network capacity and energy efficiency, as well as reduce the impact of data packet losses on users.

For example, a network should be able to handle groups of packets based on how critical they are to the user experience. Some groups of data packets hold application data units that are handled together (e.g., decoded) by the application. 3GPP defines the term “Protocol Data Unit set” (or, “PDU set”) to identify these groups of data packets carrying the payload of an application data unit, which can correspond to the data packets of a Network Application Layer (NAL) unit. Application data units can depend on other application data units to be handled or decoded by the application (e.g., P-frames depend on I-frames, and higher layers depend on lower layers, etc.).

The network can perform differentiated handling of groups of data packets, e.g., to prioritize the transmission of some groups of packets over others in cases of network congestion. The network can also selectively drop data packets that depend on an already lost application data unit. The network can also strategically limit wake-up times (i.e., of radios) to transmit and receive data. Thus, a packet scheduler can benefit from information on the size and periodicity of traffic, as well as the delay budget and expected jitter for a particular application. Efficient handling of high-throughput and low-latency traffic may therefore include differentiated handling of groups of packets, as well as the configuring of lower-layer scheduling.

In the case of high-throughput and low latency applications, such as XR applications, it has been proposed that, when a “required” PDU (i.e., a PDU that needs to be delivered successfully in order to be useful to the application layer) is lost, e.g., if it cannot be delivered before expiry of its Packet Data Convergence Protocol (PDCP) discard timer, then the whole PDU set that the required PDU belongs to can be discarded.

According to the quality of experience (QoE) feature of NR, a User Equipment (UE) device can report application layer measurements (i.e., QoE measurement results) to the network. The Access Stratum (AS) of the UE can obtain such measurements from the application layer. Because PDU sets may be treated as application layer data units, discarding an entire PDU set can impact an application's operation in a significant way-and thus lead to a low-quality user experience. Therefore, it may be beneficial for the network (e.g., the Radio Access Network (RAN) and/or the Operations, Administration, Maintenance (OAM) protocol) to be informed about user experience levels in a timely fashion when data unit (e.g., PDU set) discarding has occurred.

### SUMMARY

In accordance with one or more embodiments, a method of operating a user equipment (UE) is disclosed herein, the method comprising: detecting an event at the UE, wherein the event comprises one or more buffered data units being discarded by the UE; and triggering, in response to the detected event, the UE to report an application layer measurement result to a base station. According to some aspects, one or more of the buffered data units comprises a protocol data unit (PDU) set, and wherein each PDU set comprises one or more PDUs. According to some aspects, the application layer measurement result comprises a Quality of Experience (QoE) measurement result. As may be understood, the discarding of the one or more buffered data units may result in a decreased amount of overall data remaining in a buffer of the UE.

According to other aspects, detecting the event may comprise detecting at least one of the following exemplary conditions at the UE: (a) a threshold number of PDU sets being discarded by the UE over a first period of time; (b) a threshold number of consecutive PDU sets being discarded by the UE; (c) a threshold percentage of PDU sets within a data burst being discarded by the UE; (d) a threshold number of consecutive PDU sets within a data burst being discarded by the UE; (e) a threshold number of consecutive PDUs in a PDU set being discarded by the UE; (f) a threshold number of PDUs in a PDU set failing to be delivered; (g) a threshold number or percentage of PDUs in a PDU set experiencing congestion; (h) a threshold number of PDU sets experiencing congestion; or (i) a threshold amount of buffered data being discarded by the UE. According to some aspects, one or more of conditions (a)-(i) may occur in one or more logical channels (LCHs), logical channel groups (LCGs), Quality of Service (QoS) flows, PDU sessions, or a particular type of PDU set.

According to some aspects, the method may further comprise the UE incrementing a counter any time a data unit is discarded, wherein detecting the event further comprises detecting that the counter has met or exceeded a counter threshold value. According to some aspects, the method may further comprise the UE starting a timer when a first data unit is discarded, wherein detecting the event further comprises evaluating a status of the timer (e.g., determining whether the timer is still running).

According to other aspects, a first combination of one or more conditions that trigger the UE to report the QoE measurement result may be preconfigured at the UE by the base station. For example, the first combination of one or more conditions may apply to one of the following: a particular LCH; a particular LCG; a particular radio bearer; a particular QoS flow; a particular PDU session; a particular XR application traffic flow; a particular type of PDU set; or a particular service data flow (SDF).

According to some aspects, a base station may further configure the UE with one or more application layer measurement configurations related to the first combination of one or more conditions that trigger the UE to report the QoE measurement result.

According to some aspects, the method may further comprise the base station configuring the UE with a particular type of QoE measurement result to report to the base station, wherein, e.g., the type of QoE measurement result may comprise one of: a container-based QoE measurement result; or a RAN-visible QoE measurement result. The RAN-visible QoE measurement may comprise at least one of: an application initial playout delay value; or an application buffer level.

According to some aspects, the first combination of one or more conditions are included by the base station in an Application Layer Measurement Configuration (appLayerMeasConfig) message.

According to some aspects, the reporting of the application layer measurement result to the base station may be configured to be aperiodic. According to other aspects, the reporting of the application layer measurement result to the base station may be configured to be periodic, and the UE may change a reporting characteristic (e.g., periodicity) when one or more conditions related to buffered data unit discarding have been met.

According to some aspects, the UE is further configured to determine one or more RAN-visible QoE measurement results to be reported based on the first combination of one or more conditions. According to some aspects, the reporting of the application layer measurement result may be triggered by one of: the UE Access Stratum (AS); or the UE Application Layer.

The various methods and techniques summarized in this section may likewise be performed by a UE device comprising: a receiver; a transmitter; and a processor configured to perform any of the various methods and techniques summarized herein. The various methods and techniques summarized in this section may likewise be stored as instructions in a non-volatile computer-readable medium, wherein the instructions, when executed, cause the performance of the various methods and techniques summarized herein.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

A better understanding of the present subject matter may be obtained when the following detailed description of various aspects is considered in conjunction with the following drawings:

FIG. 1 illustrates an example wireless communication system, according to some aspects.

FIG. 2 illustrates another example of a wireless communication system, according to some aspects.

FIG. 3 illustrates an example block diagram of a UE, according to some aspects.

FIG. 4 illustrates an example block diagram of a Base Station (BS), according to some aspects.

FIG. 5 illustrates exemplary PDU sets containing different numbers of data packets, according to some aspects.

FIG. 6 illustrates exemplary mappings of PDU sets to Quality of Service (QoS) flows and data radio bearers (DRBs), according to some aspects.

FIG. 7 illustrates a flow diagram detailing a method of reporting application layer measurement results to a base station in response to a UE detecting events related to buffered data unit discarding, according to some aspects.

While the features described herein may be susceptible to various modifications and alternative forms, specific aspects thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

The present disclosure relates to improved user equipment (UE) behaviors in instances of the discarding of data units (e.g., packets, Protocol Data Units (PDU), PDU sets, etc.). There are various scenarios wherein the proactive dropping of buffered data units may occur, e.g., if all of the packets in a PDU set need to be delivered successfully to be useful for the application layer, it would not be necessary to transmit all packets of the PDU set if one or more have already failed to be delivered. Based on the “Quality of Experience” (QoE) feature of New Radio, a UE can report application layer measurement results (e.g., QoE measurements) to the network. In 3GPP Release-18, “event-triggered QoE reporting,” i.e., non-periodic QoE reporting, may be used when certain conditions are met. Thus, it may be beneficial for the network to know about user experience levels whenever certain data unit discarding events have occurred.

The following is a glossary of additional terms that may be used in this disclosure:

Memory Medium—Any of various types of non-transitory memory devices or storage devices. The term “memory medium” is intended to include an installation medium, (e.g., a CD-ROM, floppy disks, or tape device; a computer system memory or random-access memory such as DRAM, DDR RAM, SRAM, EDO RAM, Rambus RAM), a non-volatile memory such as a Flash, magnetic media (e.g., a hard drive, or optical storage; registers, or other similar types of memory elements). The memory medium may include other types of non-transitory memory as well or combinations thereof. In addition, the memory medium may be located in a first computer system in which the programs are executed or may be located in a second different computer system which connects to the first computer system over a network, such as the Internet. In the latter instance, the second computer system may provide program instructions to the first computer for execution. The term “memory medium” may include two or more memory mediums which may reside in different locations (e.g., in different computer systems that are connected over a network). The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic.”

User Equipment (UE) (also “User Device,” “UE Device,” or “Terminal”)—any of various types of computer systems or devices that are mobile or portable and that perform wireless communications. Examples of UE devices include mobile telephones or smart phones (e.g., iPhone™, Android™-based phones), portable gaming devices (e.g., Nintendo Switch™, Nintendo DS™, Play Station Vita™, Play Station Portable™, Gameboy Advance™, iPhone™), laptops, wearable devices (e.g., smart watch, smart glasses), PDAs, portable Internet devices, music players, data storage devices, other handheld devices, in-vehicle infotainment (IVI), in-car entertainment (ICE) devices, an instrument cluster, head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine type communications (MTC) devices, machine-to-machine (M2M), internet of things (IoT) devices, and the like. In general, the terms “UE” or “UE device” or “terminal” or “user device” may be broadly defined to encompass any electronic, computing, and/or telecommunications device (or combination of devices) that is easily transported by a user (or vehicle) and capable of wireless communication.

Wireless Device—any of various types of computer systems or devices that perform wireless communications. A wireless device may be portable (or mobile) or may be stationary or fixed at a certain location. A UE is an example of a wireless device.

Communication Device—any of various types of computer systems or devices that perform communications, where the communications may be wired or wireless. A communication device may be portable (or mobile) or may be stationary or fixed at a certain location. A wireless device is an example of a communication device. A UE is another example of a communication device.

Base Station—The terms “base station,” “wireless base station,” or “wireless station” have the full breadth of their ordinary meaning, and at least includes a wireless communication station installed at a fixed location and used to communicate as part of a wireless telephone system or radio system. For example, if the base station is implemented in the context of LTE, it may alternately be referred to as an ‘eNodeB’ or ‘eNB’. If the base station is implemented in the context of 5G NR, it may alternately be referred to as a ‘gNodeB’ or ‘gNB’. Although certain aspects are described in the context of LTE or 5G NR, references to “eNB,” “gNB,” “nodeB,” “base station,” “NB,” and the like, may refer to one or more wireless nodes that service a cell to provide a wireless connection between user devices and a wider network generally and that the concepts discussed are not limited to any particular wireless technology. Although certain aspects are described in the context of LTE or 5G NR, references to “eNB,” “gNB,” “nodeB,” “base station,” “NB,” and the like, are not intended to limit the concepts discussed herein to any particular wireless technology and the concepts discussed may be applied in any wireless system.

Node—The term “node,” or “wireless node” as used herein, may refer to one more apparatus associated with a cell that provide a wireless connection between user devices and a wired network generally.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an Application Specific Integrated Circuit (ASIC), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, and the like). For example, LTE may support scalable channel bandwidths from 1.4 MHz to 20 MHz. WLAN channels may be 22 MHz wide while Bluetooth channels may be 1 Mhz wide. Other protocols and standards may include different definitions of channels. Furthermore, some standards may define and use multiple types of channels (e.g., different channels for uplink or downlink and/or different channels for different uses such as data, control information, and the like).

Band—The term “band” has the full breadth of its ordinary meaning, and at least includes a section of spectrum (e.g., radio frequency spectrum) in which channels are used or set aside for the same purpose.

Configured to—Various components may be described as “configured to” perform a task or tasks. In such contexts, “configured to” is a broad recitation generally meaning “having structure that” performs the task or tasks during operation. As such, the component may be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component may be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

### Example Wireless Communication System

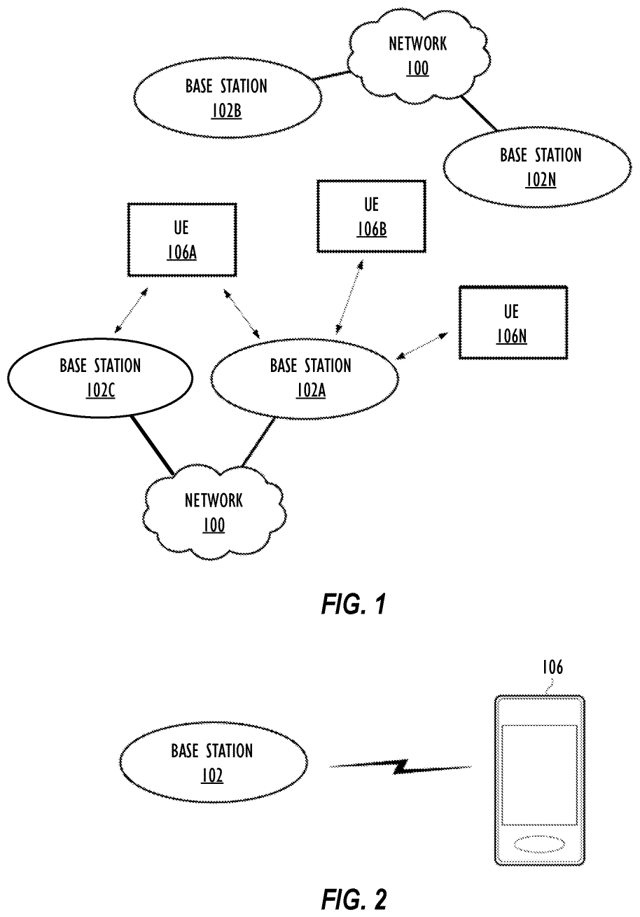

Turning now to FIG. 1, a simplified example of a wireless communication system is illustrated, according to some aspects. It is noted that the system of FIG. 1 is a non-limiting example of a possible system, and that features of this disclosure may be implemented in any of various systems, as desired.

As shown, the example wireless communication system includes a base station 102A, which communicates over a transmission medium with one or more user devices 106A and 106B, through 106N. Each of the user devices may be referred to herein as a “user equipment” (UE). Thus, the user devices 106 are referred to as UEs or UE devices.

The base station (BS) 102A may be a base transceiver station (BTS) or cell site (e.g., a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-A, 5G NR, HSPA, 3GPP2CDMA2000. Note that if the base station 102A is implemented in the context of LTE, it may alternately be referred to as an ‘eNodeB’ or ‘eNB’. Note that if the base station 102A is implemented in the context of 5G NR, it may alternately be referred to as a ‘gNodeB’ or ‘gNB’.

In some aspects, the UEs 106 may be IoT UEs, which may comprise a network access layer designed for low-power IoT applications utilizing short-lived UE connections. An IoT UE may utilize technologies such as M2M or MTC for exchanging data with an MTC server or device via a public land mobile network (PLMN), proximity service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. As an example, vehicles to everything (V2X) may utilize ProSe features using an SL interface for direct communications between devices. The IoT UEs may also execute background applications (e.g., keep-alive messages, status updates, and the like) to facilitate the connections of the IoT network.

As shown, the UEs 106, such as UE 106A and UE 106B, may directly exchange communication data via an SL interface 108. The SL interface 108 may be a PC5 interface comprising one or more physical channels, including but not limited to a Physical Sidelink Shared Channel (PSSCH), a Physical Sidelink Control Channel (PSCCH), a Physical Sidelink Broadcast Channel (PSBCH), and a Physical Sidelink Feedback Channel (PSFCH).

In V2X scenarios, one or more of the base stations 102 may be or act as Road Side Units (RSUs). The term RSU may refer to any transportation infrastructure entity used for V2X communications. An RSU may be implemented in or by a suitable wireless node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs (VUEs). The RSU may also include internal data storage circuitry to store intersection map geometry, traffic statistics, media, as well as applications/software to sense and control ongoing vehicular and pedestrian traffic. The RSU may operate on the 5.9 GHz Intelligent Transport Systems (ITS) band to provide very low latency communications required for high speed events, such as crash avoidance, traffic warnings, and the like. Additionally, or alternatively, the RSU may operate on the cellular V2X band to provide the aforementioned low latency communications, as well as other cellular communications services. Additionally, or alternatively, the RSU may operate as a Wi-Fi hotspot (2.4 GHz band) and/or provide connectivity to one or more cellular networks to provide uplink and downlink communications. The computing device(s) and some or all of the radio frequency circuitry of the RSU may be packaged in a weather enclosure suitable for outdoor installation, and it may include a network interface controller to provide a wired connection (e.g., Ethernet) to a traffic signal controller and/or a backhaul network.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B through 102N) operating according to the same or a different cellular communication standard may thus be provided as a network of cells, which may provide continuous or nearly continuous overlapping service to UEs 106A-106N and similar devices over a geographic area via one or more cellular communication standards.

Thus, while base station 102A may act as a “serving cell” for UEs 106A-106N as illustrated in FIG. 1, each UE 106 may also be capable of receiving signals from (and possibly within communication range of) one or more other cells (which may be provided by base stations 102B-102N and/or any other base stations), which may be referred to as “neighboring cells.” Such cells may also be capable of facilitating communication between user devices and/or between user devices and the network 100. Such cells may include “macro” cells, “micro” cells, “pico” cells, and/or cells which provide any of various other granularities of service area size. For example, base stations 102A and 102B illustrated in FIG. 1 may be macro cells, while base station 102Z may be a micro cell. Other configurations are also possible.

In some aspects, base station 102A may be a next generation base station, (e.g., a 5G New Radio (5G NR) base station, or “gNB”). In some aspects, a gNB may be connected to a legacy evolved packet core (EPC) network and/or to a NR core (NRC)/5G core (5GC) network. In addition, a gNB cell may include one or more transition and reception points (TRPs). In addition, a UE capable of operating according to 5G NR may be connected to one or more TRPs within one or more gNBs. For example, it may be possible that that the base station 102A and one or more other base stations 102 support joint transmission, such that UE 106 may be able to receive transmissions from multiple base stations (and/or multiple TRPs provided by the same base station). For example, as illustrated in FIG. 1, both base station 102A and base station 102C are shown as serving UE 106A.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, and the like) in addition to at least one of the cellular communication protocol discussed in the definitions above. The UE 106 may also or alternatively be configured to communicate using one or more global navigational satellite systems (GNSS) (e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

As illustrated in FIG. 2, in one or more embodiments, the UE 106 may be a device with cellular communication capability such as a mobile phone, a hand-held device, a computer, a laptop, a tablet, a smart watch, or other wearable device, or virtually any type of wireless device.

The UE 106 may include a processor (processing element) that is configured to execute program instructions stored in memory. The UE 106 may perform any of the method aspects described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method aspects described herein, or any portion of any of the method aspects described herein.

The UE 106 may include one or more antennas for communicating using one or more wireless communication protocols or technologies. In some aspects, the UE 106 may be configured to communicate using, for example, NR or LTE using at least some shared radio components. As additional possibilities, the UE 106 could be configured to communicate using CDMA2000 (1xRTT/1xEV-DO/HRPD/eHRPD) or LTE using a single shared radio and/or GSM or LTE using the single shared radio. The shared radio may couple to a single antenna, or may couple to multiple antennas (e.g., for a multiple-input multiple output (MIMO) configuration) for performing wireless communications. In general, a radio may include any combination of a baseband processor, analog RF signal processing circuitry (e.g., including filters, mixers, oscillators, amplifiers, and the like), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1xRTT, or either of LTE or GSM, among various possibilities), and separate radios for communicating using each of Wi-Fi and Bluetooth. Other configurations are also possible.

In some aspects, a downlink resource grid may be used for downlink transmissions from any of the base stations 102 to the UEs 106, while uplink transmissions may utilize similar techniques. The grid may be a time-frequency grid, called a resource grid or time-frequency resource grid, which is the physical resource in the downlink in each slot. Such a time-frequency plane representation is a common practice for Orthogonal Frequency Division Multiplexing (OFDM) systems, which makes it intuitive for radio resource selection. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid may comprise a number of resource blocks, which describe the mapping of certain physical channels to resource elements. Each resource block comprises a collection of resource elements. There are several different physical downlink channels that are conveyed using such resource blocks.

The physical downlink shared channel (PDSCH) may carry user data and higher layer signaling to the UEs 106. The physical downlink control channel (PDCCH) may carry information about the transport format and resource allocations related to the PDSCH channel, among other things. It may also inform the UEs 106 about the transport format, resource allocation, and HARQ (Hybrid Automatic Repeat Request) information related to the uplink shared channel. Typically, downlink scheduling (assigning control and shared channel resource blocks to the UE 102 within a cell) may be performed at any of the base stations 102 based on channel quality information fed back from any of the UEs 106. The downlink resource assignment information may be sent on the PDCCH used for (e.g., assigned to) each of the UEs.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH may be transmitted using one or more CCEs, depending on the size of the Downlink Control Information (DCI) and the channel condition. There may be four or more different PDCCH formats defined in LTE with different numbers of CCEs (e.g., aggregation level, L=1, 2, 4, or 8).

### Example Communication Device

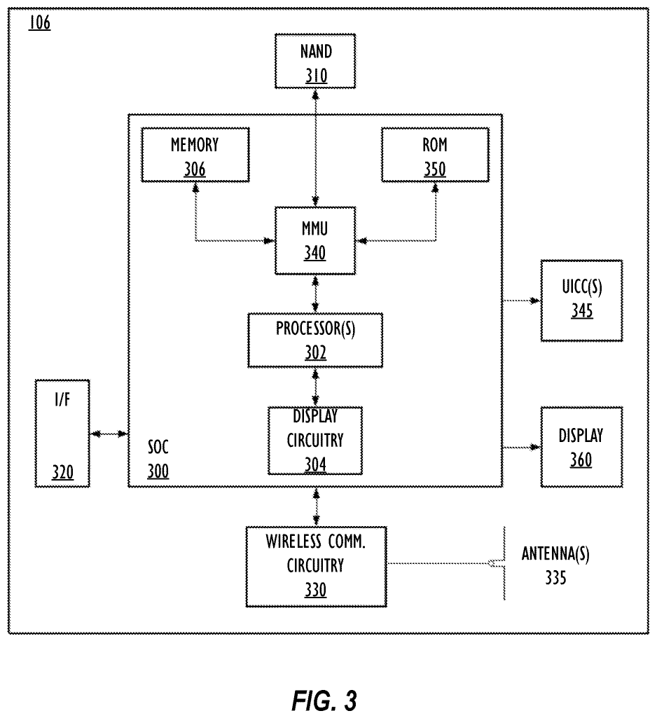

FIG. 3 illustrates an example simplified block diagram of a communication device 106, according to some aspects. It is noted that the block diagram of the communication device of FIG. 3 is only one example of a possible communication device. According to aspects, communication device 106 may be a UE device or terminal, a mobile device or mobile station, a wireless device or wireless station, a desktop computer or computing device, a mobile computing device (e.g., a laptop, notebook, or portable computing device), a tablet, and/or a combination of devices, among other devices. As shown, the communication device 106 may include a set of components configured to perform core functions. For example, this set of components may be implemented as a system on chip (SOC), which may include portions for various purposes. Alternatively, this set of components may be implemented as separate components or groups of components for the various purposes. The set of components may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; and the like), the display 360, which may be integrated with or external to the communication device 106, and wireless communication circuitry 330 (e.g., for LTE, LTE-A, NR, UMTS, GSM, CDMA2000, Bluetooth, Wi-Fi, NFC, GPS, and the like). In some aspects, communication device 106 may include wired communication circuitry (not shown), such as a network interface card (e.g., for Ethernet connection).

The wireless communication circuitry 330 may couple (e.g., communicatively; directly or indirectly) to one or more antennas, such as antenna(s) 335 as shown. The wireless communication circuitry 330 may include cellular communication circuitry and/or short to medium range wireless communication circuitry, and may include multiple receive chains and/or multiple transmit chains for receiving and/or transmitting multiple spatial streams, such as in a MIMO configuration.

In some aspects, as further described below, cellular communication circuitry 330 may include one or more receive chains (including and/or coupled to (e.g., communicatively; directly or indirectly) dedicated processors and/or radios) for multiple Radio Access Technologies (RATs) (e.g., a first receive chain for LTE and a second receive chain for 5G NR). In addition, in some aspects, cellular communication circuitry 330 may include a single transmit chain that may be switched between radios dedicated to specific RATs. For example, a first radio may be dedicated to a first RAT (e.g., LTE) and may be in communication with a dedicated receive chain and a transmit chain shared with a second radio. The second radio may be dedicated to a second RAT (e.g., 5G NR) and may be in communication with a dedicated receive chain and the shared transmit chain. In some aspects, the second RAT may operate at mm Wave frequencies. As mm Wave systems operate in higher frequencies than typically found in LTE systems, signals in the mmWave frequency range are heavily attenuated by environmental factors. To help address this attenuating, mmWave systems often utilize beamforming and include more antennas as compared LTE systems. These antennas may be organized into antenna arrays or panels made up of individual antenna elements. These antenna arrays may be coupled to the radio chains.

The communication device 106 may also include and/or be configured for use with one or more user interface elements.

The communication device 106 may further include one or more smart cards 345 that include Subscriber Identity Module (SIM) functionality, such as one or more Universal Integrated Circuit Card(s) (UICC(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, wireless communication circuitry 330, connector I/F 320, and/or display 360. The MMU 340 may be configured to perform memory protection and page table translation or set up. In some aspects, the MMU 340 may be included as a portion of the processor(s) 302.

As noted above, the communication device 106 may be configured to communicate using wireless and/or wired communication circuitry. As described herein, the communication device 106 may include hardware and software components for implementing any of the various features and techniques described herein. The processor 302 of the communication device 106 may be configured to implement part or all of the features described herein (e.g., by executing program instructions stored on a memory medium). Alternatively (or in addition), processor 302 may be configured as a programmable hardware element, such as a Field Programmable Gate Array (FPGA), or as an Application Specific Integrated Circuit (ASIC). Alternatively (or in addition) the processor 302 of the communication device 106, in conjunction with one or more of the other components 300, 304, 306, 310, 320, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, and the like) configured to perform the functions of processor(s) 302.

Further, as described herein, wireless communication circuitry 330 may include one or more processing elements. In other words, one or more processing elements may be included in wireless communication circuitry 330. Thus, wireless communication circuitry 330 may include one or more integrated circuits (ICs) that are configured to perform the functions of wireless communication circuitry 330. In addition, each integrated circuit may include circuitry (e.g., first circuitry, second circuitry, and the like) configured to perform the functions of wireless communication circuitry 330.

### Example Base Station

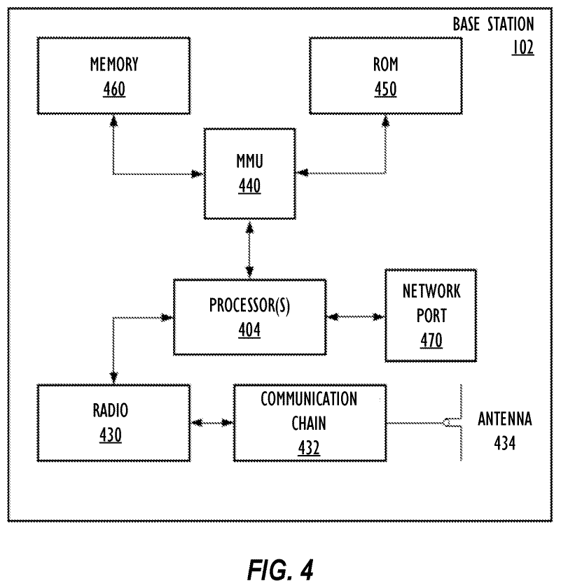

FIG. 4 illustrates an example block diagram of a base station 102, according to some aspects. It is noted that the base station of FIG. 4 is a non-limiting example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIG. 1.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some aspects, base station 102 may be a next generation base station, (e.g., a 5G New Radio (5G NR) base station, or “gNB”). In such aspects, base station 102 may be connected to a legacy evolved packet core (EPC) network and/or to a NR core (NRC)/5G core (5GC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including 5G NR, LTE, LTE-A, GSM, UMTS, CDMA2000, Wi-Fi, and the like.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. When the base station 102 supports mmWave, the 5G NR radio may be coupled to one or more mm Wave antenna arrays or panels. As another possibility, the base station 102 may include a multi-mode radio, which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, and the like).

Further, the BS 102 may include hardware and software components for implementing or supporting implementation of features described herein. The processor 404 of the base station 102 may be configured to implement or support implementation of part or all of the methods described herein (e.g., by executing program instructions stored on a memory medium). Alternatively, the processor 404 may be configured as a programmable hardware element, such as a Field Programmable Gate Array (FPGA), or as an Application Specific Integrated Circuit (ASIC), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, and the like) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, and the like) configured to perform the functions of radio 430.

### Protocol Data Unit (PDU) Sets and Quality of Service (QoS) Handling/Quality of Experience (QoE) Measurement Reporting for Delay-Sensitive Traffic

Traffic types are evolving to accommodate new use cases in developing cellular networks. For example, as mentioned above, efforts are being undertaken to improve RAN operation to support traffic having characteristics associated with extended reality (XR) traffic to provide, for example, high throughput, low-latency, and high reliability. Various enhancements to QoE reporting operation may be used to facilitate network optimization, which may in turn improve capacity and delay times for data transmission in XR application use cases. While some embodiments herein are described with reference to XR traffic and PDU sets specifically, other embodiments may apply similar concepts to other types of traffic and/or traffic that does not include data organized into PDU sets.

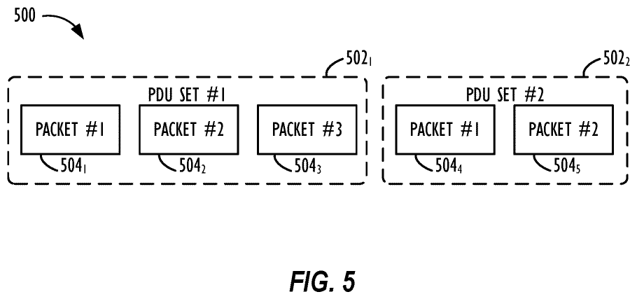

Turning now to FIG. 5, an example 500 of exemplary PDU sets 502 containing different numbers of data packets 504 are illustrated, according to some aspects. For example, a PDU set #1 (502₁) may contain packets 504₁, 504₂, and 504₃, and a PDU set #2 (502₂) may contain packets 504₄ and 504₅. XR traffic is one example of wireless data that may operate based on a PDU set. As illustrated in FIG. 5, a PDU set, may correspond to an application data unit, which may include a plurality of packets/PDUs. A user plane function (UPF) may identify a PDU set based on a PDU set sequence number (SN), a start/end PDU of the PDU set, a PDU SN within a PDU set, a number of PDUs within a PDU set, or an importance or priority level of the PDU set.

A quality of service (QoS) flow may be identified using a QoS flow ID, and each PDU set within the QoS flow may be identified using the PDU set SN. Each QoS flow can be used to deliver one or more PDU sets. The UPF may further identify information relating to the PDU set, for example, a PDU set importance or a PDU set dependency. The UPF may provide the information relating to PDU sets to a RAN. QoS parameters for PDU set-based QoS handling may include a PDU set delay budget (PSDB), a PDU set error rate (PSER), whether to drop a PDU set in case a PSDB is exceeded, whether all PDUs are needed for usage of a PDU set by an application layer, and a PDU set priority. A single QoS flow may comprise both PDU sets that have been designated as “important,” as well as PDU sets that have been designated as “non important,” and whether a particular PDU Set has been designated as important or not may help facilitate the RAN to determine if the particular PDU Set should be discarded in a given situation. A network could configure a UE to map a first QoS flow, e.g., QoS Flow 1, to a first radio bearer, e.g., Radio Bearer 1, and then map a second QoS flow, e.g., QoS Flow 2) to a second radio bearer, e.g., Radio Bearer 2, and then the network could configure different radio-related configurations and/or parameterizations for the different radio bearers (e.g., Radio Bearer 1 and Radio Bearer 2). The characteristics of a buffered PDU set (for example, an importance level of the PDU set) may also be indicated in a BSR (or other form of MAC CE, as may be used in a given implementation).

In XR applications (or other time-sensitive applications), there is the chance that some packets of a PDU set may be discarded even before they are transmitted, e.g., if the PSDB is exceeded and/or if all PDUs are not needed for the usage of PDU Set by application layer, etc. Other scenarios where proactive packet dropping may occur include: (1) if all packets in a PDU set must be delivered successfully to be useful for the application layer, then it would not be necessary to transmit all packets of a PDU set if one or more of them have already failed; (2) if at least one critical/essential PDU set has already failed, there is no need to transmit the remaining packets in the same PDU set; (3) if it is sufficient for the application layer as long as a certain portion of a PDU set is received successfully, then the transmitter may drop the remaining packets in a PDU set to save power/resources once the required portion of the PDU set has been successfully delivered; (4) if there is interdependence between different PDU sets, then the transmitter may determine to drop or continue transmitting a PDU set based on the status of another interdependent PDU set; or (5) the transmitter may proactively discard some packets in order to alleviate traffic congestion.

When a decision about packet discarding is made—regardless of the reasons for packet discarding—the packets from one or more PDU sets that are still queued in the LCH buffer may be flushed away. Therefore, the UL buffer status would experience a changed buffer condition (e.g., the buffer may become less full—or even completely empty) after the packet discarding has occurred. It would be important for the gNB to know about this change in buffer condition (i.e., due to the packet discarding) as soon as possible. Otherwise, the gNB may allocate radio resource based on an outdated understanding about the buffer's status (i.e., the buffer's status as it was before the most recent packet discarding event had occurred).

On the other hand, traffic in many XR applications is delay-sensitive and needs to be delivered within a certain time budget (e.g., a PSDB) in order for it to be useful to an application. To achieve delay-aware scheduling, it has been proposed that buffer status reporting should be enhanced to include additional information, such as queueing delay time and/or remaining time until a delivery deadline. Such information would allow the gNB to allocate uplink resources in a timelier fashion.

As mentioned above, according to the so-called quality of experience (QoE) feature of NR, a UE can report various application layer measurements (i.e. QoE measurements) to the network. The AS of the UE can obtain such measurements from the application layer. QoE measurements can be classified into “container-based” (i.e., non-RAN visible) measurements or “RAN-visible” measurements. In 3GPP Release-17, only periodic QoE reporting was supported. However, for 3GPP Release-18, so-called “event-triggered QoE reporting” (i.e., non-periodic QoE reporting) has been proposed, wherein a UE would perform QoE measurement reporting whenever certain conditions were met. A number of different event triggering conditions are possible, e.g.: events relating to channel quality (e.g., QoE reporting may be triggered when the reference signal received power (RSRP) or reference signal received quality (RSRQ) drops below a threshold); events relating to UE mobility (e.g., QoE reporting may be triggered when the UE's mobility is higher than a threshold value); events relating to UE location (e.g., QoE reporting may be triggered when the UE enters a certain geographical region); events relating to buffer level (e.g., QoE reporting may be triggered when a UE data buffer level drops below a threshold value); or events relating to application playout delay (e.g., QoE reporting may be triggered when the playout delay for a given application exceeds a threshold value).

Thus, according to some aspects disclosed herein, an event-triggered QoE reporting scheme is proposed that is based on various conditions related to data unit discarding (e.g., PDU and/or PDU Set discarding). According to some such aspects, the QoE reporting may be triggered by either the Access Stratum (AS) or the Application layer (assuming that the UE AS and UE Application layer can interact and exchange information based on UE implementation).

In the case of event QoE reporting triggered by the UE AS, when sufficient conditions relating to data unit discarding are met, the UE AS may notify the UE Application layer and ask the UE Application layer to provide the QoE measurement results to the UE AS for timely reporting.

In the case of event QoE reporting triggered by the UE Application Layer, when the conditions relating to data unit discarding are met, the UE AS may notify the UE Application layer (potentially with some additional details, such as how many PDUs or PDU Sets have been discarded, or if any PDU sets designated as being important PDU sets have been discarded, etc.). The UE Application layer may then decide if there is a need to trigger reporting of QoE measurements yet. If the UE Application layer decides QoE reporting is needed, it may further provide the QoE measurement results to the UE AS for timely reporting. Alternatively, the UE Application Layer may also trigger QoE reporting if the data unit discarding occurs in the Application Layer itself.

According to some aspects, examples of various conditions related specifically to PDU set discarding that may be utilized to trigger QoE reporting may include: (a) when a number, “N” (e.g., wherein N is an integer larger than or equal to 1), of PDU Sets are discarded over a period of time; (b) when N consecutive PDU Sets are discarded; (c) when N PDU Sets (or a percentage of PDU Sets) within a particular data burst are discarded; (d) when N consecutive PDU Sets within a data burst are discarded; (e) when N (consecutive) PDUs (or a percentage of PDUs) in a PDU Sets are discarded; (f) when N (consecutive) PDUs (or a percentage of PDUs) in a PDU Sets fail to be delivered within an allotted time; (g) when N PDUs in a PDU set, or N PDU Sets have experienced congestion; (h) when N PDUs in a PDU set fail to be delivered within an allotted time; or (i) when a threshold amount of buffered data has been discarded by the UE, e.g., in terms of a number of bits (as, in some aspects, the UE may instead rely on checking a resultant buffer status value, rather than determining whether the discarding of any particular number of any particular type(s) of data units has been performed).

According to some aspects, a QoE report may be triggered when any one or more of above conditions (a)-(i) occurs in one or more LCHs, LCGs, QoS flows, and/or PDU sessions. According to other aspects, a QoE report may be triggered when any one or more of above conditions (a)-(i) occurs in a particular type of PDU Set (e.g., QoE reports may only be triggered by the discarding of important PDU Sets within a QoS flow for a particular implementation). For example, in some applications, the network may not be concerned if data is discarded from an application's audio channel, but it may want to immediately trigger QoE reporting if a threshold amount of data is discarded from that same application's video channel. As another example, for a video traffic flow, the UE may only trigger QoE reporting when a number, N, of I-Frames (which may, in this example, be designated as being “important” types of PDU Sets) are discarded; whereas, it may not trigger QoE reporting if all N of the discarded PDU sets are corresponding to P-Frames (i.e., a PDU set type that is not designated as being important in this particular example).

According to other aspects, in order to evaluate whether any of the conditions (a)-(i) above are met, the UE may use a counter or a timer. For example, considering condition (a) above, the UE may initialize a counter value to zero (and may also optionally start a timer). Then, the UE may increment the counter value by 1 any time that a PDU Set (or other relevant type of data unit, for a given implementation) is discarded. Finally, the UE may trigger the QoE reporting whenever the counter value reaches the threshold value, N. (In cases where a timer has been started, the UE may also optionally confirm that the timer is still running once the Nth PDU set has been discarded.) Once the QoE report has been triggered, the counter value may be reset back to 0.

The particular set of one or more conditions relating to data unit discarding that trigger QoE reporting by the UE may be pre-configured by the network. For example, a gNB can pre-configure the UE with various guidelines and information about triggering events evaluation (e.g., the value of threshold, N, mentioned above, the applicable application layer measurement configuration ID, the applicable LCHs or LCGs, importance level of PDU sets, etc.), so that the UE can evaluate whether the conditions for triggering the QoE reporting are met.

According to some aspects, a network may configure UE behavior related to the triggering of QoE reporting based on data unit discarding (e.g., PDU set discarding) in various different ways. For example, the network configuration may be specified: per LCH, per LCG, per radio bearer, per QoS flow, per PDU session, per XR traffic flow, per PDU set type/importance level, per service data flow (SDF), etc. For example, if a PDU set discarding occurred in the data from at least one of the configured LCHs, then it may mean that the UE should trigger QoE reporting (whereas, if the discarding instead occurred in other, i.e., non-configured, LCHs, it may not trigger the UE to perform QoE reporting).

In the configuration, the network may also further indicate which Application Layer Measurement Configuration(s) is applicable to this LCH, LCG, radio bearer, QoS flow, and/or PDU session. Thus, when the conditions relating to the relevant data unit discarding are met, the UE will be aware of which Application Layer Measurement Configuration(s) the QoE reporting should be triggered on. In other aspects, the network configuration may further indicate the specific value of ‘N’ (as discussed above) for the UE to use in its triggering evaluation. In still other aspects, the value of ‘N’ may be fixed by Specification, and thus would not need to be configured by the network. In yet other aspects, the network configuration may further indicate which particular type(s) of QoE measurements (e.g., container-based QoE measurements and/or RAN-visible QoE measurements) should be reported when the conditions are met.

In the case of Application Layer Measurement Configuration, for example, the conditions relating to data unit discarding that can trigger QoE reporting may be included in the message of appLayerMeasConfig. In the configuration, the network may further indicate which LCH, LCG, radio bearer, QoS flow, and/or PDU session, etc. is applicable. The network may also indicate the value of N in the configuration. Similarly, the network may also further indicate in the configuration which type(s) of QoE measurements (e.g., container-based QoE measurements and/or RAN-visible QoE measurements) should be reported when the conditions are met.

According to some aspects, when the conditions relating to data unit discarding are met, the UE may also perform the following behaviors: (1) if periodic QoE reporting has been configured (e.g., every 120 ms), the UE may change a QoE reporting characteristic, such as the QoE reporting periodicity (e.g., so as to report the QoE more frequently) when the conditions relating to PDU set discarding are met; (2) if QoE reporting has been paused, the UE may refrain from triggering QoE reporting; (3) if QoE reporting has been paused, the UE may still trigger QoE reporting (e.g., if the UE determines that data discarding has become a serious issue to the application); or (4) the UE may determine the RAN-visible QoE measurements to be reported (e.g., depending on the condition(s) that trigger the QoE report, the UE may select which types of RAN-visible QoE measurements to include in the QoE report).

In some further aspects, new types of QoE measurements (e.g., RAN-visible QoE measurements) that are to be reported may be introduced. For example: (1) the number of discarded PDU Sets with a data burst; (2) the average number of discarded PDU Sets across multiple data bursts; (3) the number of discarded PDUs within a given (discarded) PDU Set; (4) the average number of discarded PDUs among multiple discarded PDU Sets; (5) the number of PDUs that failed to be delivered before the discarding of a PDU set; (6) the average number of PDUs that failed to be delivered before the discarding of multiple PDU sets; (7) the (average) amount of time taken to fully deliver a PDU set after its PSDB has been exceeded; or (8) the number of discarded PDU sets that are designated as being an important type for a particular application. Other types of QoE measurements are also possible, within the scope of this disclosure, to fit the needs of a given implementation. Notably, in some implementations, if significant/relevant data unit discarding has occurred in the downlink (DL) channel, the network may send a control signal to the UE in order to preemptively trigger QoE reporting from the UE.

### Exemplary Mapping Alternatives of PDU Sets onto Quality of Service (QoS) Flows

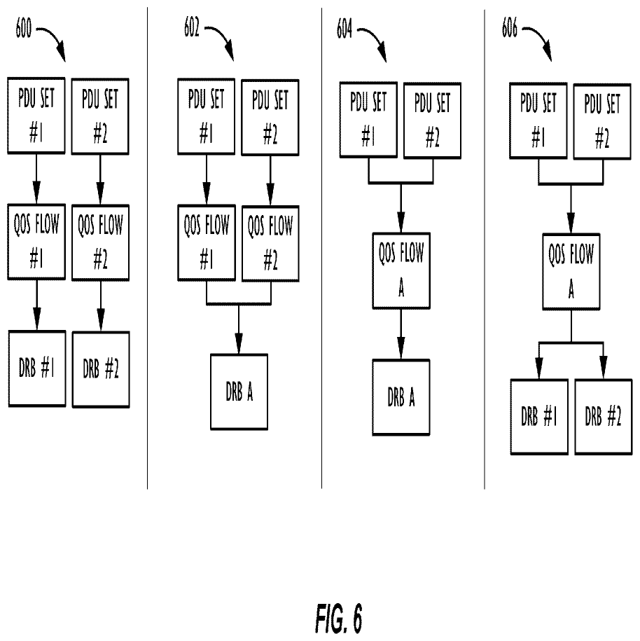

Depending on how the mapping of PDU Sets onto QoS flows is done in the Network Access Stratum (NAS) and how QoS flows are mapped onto DRBs in the AS, various alternatives may be employed in a given implementation. Turning now to FIG. 6, exemplary mappings of PDU sets to Quality of Service (QoS) flows and data radio bearers (DRBs) are illustrated, e.g., as depicted in FIG. 5.1.2-1 of 3GPP TS 38.835.

Turning first to alternative 600, one-to-one mapping between types of PDU Sets and QoS flows in the NAS, as well as one-to-one mapping between QoS flows and DRBs in the AS are shown. From a Layer 2 structure viewpoint, this alternative is already possible and requires as many DRBs as types of PDU Sets. Providing different QoS for the types of PDU Sets sent in different DRBs is already possible.

Turning now to alternative 602, one-to-one mapping between types of PDU Sets and QoS flows in the NAS, and then possible multiplexing of QoS flows in one DRB in the AS are shown. From a Layer 2 structure viewpoint, this alternative is already possible but gives each QoS flow multiplexed in a DRB the same QoS level. Providing different QoS for the types of PDU Sets (i.e., QoS flows) multiplexed in a single DRB is currently not possible.

Turning now to alternative 604, the possible multiplexing of types of PDU Sets in one QoS flow in the NAS, as well as one-to-one mapping between QoS flows and DRBs in the AS are shown. From a Layer 2 structure viewpoint, this alternative is already possible but gives each QoS flow/DRB one QoS. Providing different QoS for the types of PDU Sets multiplexed in a single QoS flow/DRB is currently not possible.

Finally, turning to alternative 606, the possible multiplexing of types of PDU Sets into one QoS flow in the NAS and the demultiplexing of types of PDU Sets from one QoS flow on multiple DRBs in the AS are shown. From a Layer 2 structure viewpoint, demultiplexing of types of PDU Sets from one QoS flow onto multiple DRBs is not currently possible.

### Exemplary Methods

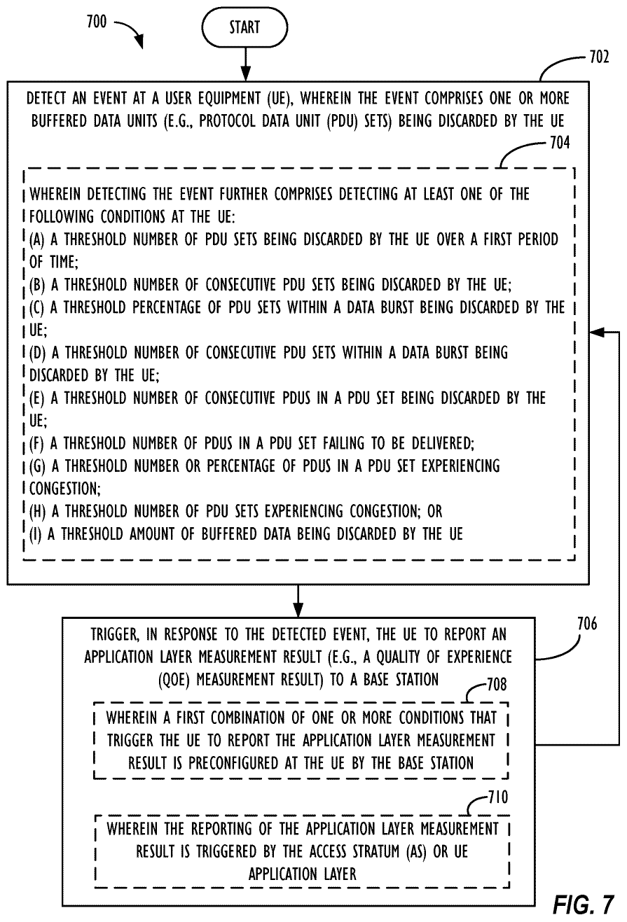

Turning now to FIG. 7, a flowchart 700 detailing a method of reporting application layer measurement results to a base station in response to a UE detecting events related to buffered data unit discarding is illustrated, according to some aspects. First, at block 702, a UE practicing the method of 700 may detect an event at a UE, wherein the event comprises one or more buffered data units (e.g., PDU sets) being discarded by the UE. As shown at block 704, detecting the event may further comprise detecting at least one of the following conditions at the UE: (a) a threshold number of PDU sets being discarded by the UE over a first period of time; (b) a threshold number of consecutive PDU sets being discarded by the UE; (c) a threshold percentage of PDU sets within a data burst being discarded by the UE; (d) a threshold number of consecutive PDU sets within a data burst being discarded by the UE; (e) a threshold number of consecutive PDUs in a PDU set being discarded by the UE; (f) a threshold number of PDUs in a PDU set failing to be delivered; (g) a threshold number or percentage of PDUs in a PDU set experiencing congestion; (h) a threshold number of PDU sets experiencing congestion; or (i) a threshold amount of buffered data being discarded by the UE.

Next, at block 706, a UE practicing the method of 700 may trigger, in response to the detected event, the reporting of an application layer measurement result (e.g., a quality of experience (QoE) measurement result) to a base station. As illustrated at block 708, according to some aspects, a first combination of one or more conditions that trigger the UE to report the application layer measurement result is preconfigured at the UE by the base station. As illustrated at block 710, according to other aspects, the reporting of the application layer measurement result may be triggered by the UE Access Stratum (AS) or the UE Application Layer. Finally, the UE practicing the method of 700 may return operations to block 702, wherein the UE may continue to monitor for the occurrence of other events related to buffered data unit discarding, which may, in turn, have an impact on the user of the UE's QoE level.

### Additional Comments

The use of the connective term “and/or” is meant to represent all possible alternatives of the conjunction “and” and the conjunction “or.” For example, the sentence “configuration of A and/or B” includes the meaning and of sentences “configuration of A and B” and “configuration of A or B.”

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Aspects of the present disclosure may be realized in any of various forms. For example, some aspects may be realized as a computer-implemented method, a computer-readable memory medium, or a computer system. Other aspects may be realized using one or more custom-designed hardware devices such as ASICs. Still other aspects may be realized using one or more programmable hardware elements such as FPGAs.

In some aspects, a non-transitory computer-readable memory medium may be configured so that it stores program instructions and/or data, where the program instructions, if executed by a computer system, cause the computer system to perform a method (e.g., any of a method aspects described herein, or, any combination of the method aspects described herein, or any subset of any of the method aspects described herein, or any combination of such subsets).

In some aspects, a device (e.g., a UE 106, a BS 102) may be configured to include a processor (or a set of processors) and a memory medium, where the memory medium stores program instructions, where the processor is configured to read and execute the program instructions from the memory medium, where the program instructions are executable to implement any of the various method aspects described herein (or, any combination of the method aspects described herein, or, any subset of any of the method aspects described herein, or, any combination of such subsets). The device may be realized in any of various forms.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. A method of operating a user equipment (UE), the method comprising:
detecting an event at the UE, wherein the event comprises one or more buffered data units being discarded by the UE; and
triggering, in response to the detected event, the UE to report an application layer measurement result to a base station.

2. The method of claim 1, wherein one or more of the buffered data units comprises a protocol data unit (PDU) set, and wherein each PDU set comprises one or more PDUs.

3. The method of claim 1, wherein the application layer measurement result comprises a Quality of Experience (QoE) measurement result.

4. The method of claim 2, wherein detecting the event further comprises detecting at least one of the following conditions at the UE:
(a) a threshold number of PDU sets being discarded by the UE over a first period of time;
(b) a threshold number of consecutive PDU sets being discarded by the UE;
(c) a threshold percentage of PDU sets within a data burst being discarded by the UE;
(d) a threshold number of consecutive PDU sets within a data burst being discarded by the UE;
(e) a threshold number of consecutive PDUs in a PDU set being discarded by the UE;
(f) a threshold number of PDUs in a PDU set failing to be delivered;
(g) a threshold number or percentage of PDUs in a PDU set experiencing congestion;
(h) a threshold number of PDU sets experiencing congestion; or
(i) a threshold amount of buffered data being discarded by the UE.

5. The method of claim 4, wherein one or more of conditions (a)-(i) occur in one or more logical channels (LCHs), logical channel groups (LCGs), Quality of Service (QoS) flows, types of PDU sets, or PDU sessions.

6. The method of claim 4, wherein one or more of conditions (a)-(i) occur in a particular type of PDU set that has been designated as being important.

7. (canceled)

8. The method of claim 1, further comprising:
the UE incrementing a counter any time a data unit is discarded,
wherein detecting the event further comprises detecting that the counter has met or exceeded a counter threshold value.

9. The method of claim 8, further comprising:
the UE starting a timer when a first data unit is discarded,
wherein detecting the event further comprises evaluating a status of the timer.

10. The method of claim 3, wherein a first combination of one or more conditions that trigger the UE to report the QoE measurement result is preconfigured at the UE by the base station.

11. (canceled)

12. The method of claim 10, wherein the base station further configures the UE with one or more application layer measurement configurations related to the first combination of one or more conditions that trigger the UE to report the QoE measurement result.

13. The method of claim 10, wherein the base station further configures the UE with a type of QoE measurement result to report to the base station.

14. The method of claim 13, wherein the type of QoE measurement result comprises one of: a container-based QoE measurement result; or a RAN-visible QoE measurement result.

15. The method of claim 14, wherein the RAN-visible QoE measurement comprises at least one of: an application initial playout delay value; or an application buffer level.

16. The method of claim 10, wherein the first combination of one or more conditions are included by the base station in an Application Layer Measurement Configuration (appLayerMeasConfig) message.

17. The method of claim 1, wherein the reporting of the application layer measurement result to the base station is configured to be aperiodic.

18. The method of claim 1, wherein the reporting of the application layer measurement result to the base station is configured to be periodic, and wherein the UE may change a reporting characteristic when one or more conditions related to buffered data unit discarding have been met.

19. The method of claim 10, wherein the UE is further configured to:
determine one or more RAN-visible QoE measurement results to be reported based on the first combination of one or more conditions.

20. The method of claim 1, wherein the reporting of the application layer measurement result is triggered by one of: a UE Access Stratum (AS); or a UE Application Layer.

21. A user equipment (UE) device comprising: a receiver; a transmitter;
and a processor configured to perform operations comprising:
detecting an event at the UE, wherein the event comprises one or more buffered data units being discarded by the UE; and
triggering, in response to the detected event, the UE to report an application layer measurement result to a base station.

22. (canceled)

23. A baseband processor configured to cause a user equipment (UE) to perform operations comprising:
detecting an event at the UE, wherein the event comprises one or more buffered data units being discarded by the UE; and
triggering, in response to the detected event, the UE to report an application layer measurement result to a base station.
